(19) United States
(12) Patent Application Publication
(10) Pub. No.: US 2005/0212724 A1
(43) Pub. Date: Sep. 29, 2005

(54) Plasma display apparatus and image processing method thereof

(75) Inventor: Jun Hak Lee, Suwon (KR)

Correspondence Address: JONATHAN Y. KANG, ESQ.;LEE, HONG, DEGERMAN,, KANG & SCHMADEKA, 801 S. Figueroa Street, 14th Floor, Los Angeles, CA, 90017, US

(73) Assignee: LG Electronics Inc.

(21) Appl. No.: 11/092,852

(22) Filed: Mar. 28, 2005

(30) Foreign Application Priority Data
Mar. 29, 2004 (KR) 10-2004-0021349

(51) Int. Cl. G09G 3/28

(52) U.S. Cl. 345/60

(57) ABSTRACT

There are provided a plasma display apparatus and a Look-Up Table (LUT) used in the plasma display apparatus. The plasma display apparatus includes: a Look-Up Table (LUT) storage unit in which an object value corresponding to a variable of image data is stored; a data transmission unit transmitting decimal data corresponding to a decimal factor of the object value of the LUT; a data generator generating integer data corresponding to an integer factor of the object value in response to a change in the transmitted decimal data; and a data restoring unit restoring data corresponding to the object value using the generated integer data and the transmitted decimal data. Therefore, by improving a method for compressing data of a LUT, it is possible to reduce the time used to transmit the data of the LUT.

This nonprovisional application claims priority under 35 U.S.C. § 119(a) on Patent Application No. 10-2004-0021349 filed in Korea on Mar. 29, 2004, the entire contents of which are hereby incorporated by reference.

### BACKGROUND OF THE INVENTION

1. Field of the Invention

The present invention relates to a plasma display apparatus, more particularly, to a Look-Up Table (LUT) used in a plasma display apparatus.

2. Description of the Related Art

Generally, in a plasma display panel (PDP), discharge cells are partitioned by barrier ribs formed between a front panel and a rear panel. Each discharge cell is filled with main discharge gas, such as Ne, He, or Ne—He mixture (Ne+He), and inert gas containing a small amount of Xe. When discharge occurs by a high frequency voltage, the inert gas generates vacuum ultraviolet rays and excites phosphors formed between the barrier ribs, thereby forming an image. Such a PDP currently is in the focus of attention as a next-generation display since it is thin in thickness and light in weight.

FIG. 1 is a perspective view of a conventional PDP. Referring to FIG. 1, in the conventional PDP, a front substrate 100 including a front glass 101 on which a plurality of sustain electrode pairs, each consisting of a scan electrode 102 and a sustain electrode 103, are arranged, is coupled spacing by a predetermined distance parallel with a rear substrate 110 including a rear glass 111 on which address electrodes 113 (113 for each) are arranged in a manner to intersect the plurality of sustain electrode pairs.

The lower surface of the front substrate 100 is covered by at least a dielectric layer 104 for limiting a discharge current of the scan electrode 102 and sustain electrode 103 and insolating the electrode pairs to each other. The scan electrode 102 and the sustain electrode 103 are used to discharge a discharge cell and maintain the emission of light of the discharge cell. Each of the scan electrode 102 and the sustain electrode 103 includes a transparent electrode a made of a transparent material such as ITO (Indium Thin Oxide) and a bus electrode b made of metal material. A protection layer 105 such as a MgO layer is formed on the surface of the dielectric layer 104, in order to uniformly maintain a discharge condition.

Barrier ribs 112 (112 for each) are formed parallel with each other in a stripe type or in a well type on the rear substrate 110, to form a plurality of discharge spaces, that is, a plurality of discharge cells. Also, a plurality of address electrodes 113 (113 for each) for performing address discharge to generate vacuum ultraviolet rays are disposed parallel to the barrier ribs 112. R, G, and B phosphors 114 for emitting visible light to display an image when address discharging are formed over the rear substrate 110. A dielectric layer 115 is interposed between the address electrodes 113 and the R, G, and B phosphors 114, to protect the address electrodes 113.

FIG. 2 is a view for explaining an image processing method performed by a conventional plasma display apparatus.

Referring to FIG. 2, the conventional plasma display apparatus displays an image by dividing a frame period into a plurality of subfields which are different in the number of discharges and discharging a corresponding plasma display panel during the periods of subfields corresponding to a gray-level value of a received image signal.

Each subfield includes a reset period for uniformly generating discharge, an address period for selecting discharge cells, and a sustain period for implement a gray-level according to the number of discharges. For example, if an image is displayed in 256 gray-levels, a frame period (16.67 ms) corresponding to 1/60 second is divided into 8 subfields.

Each of the 8 subfields is divided into a reset period, an address period, and a sustain period. Here, the lengths of the sustain periods of the 8 subfields sequentially increase at the rate of 2ⁿ (n=0, 1, 2, 3, 4, 5, 6, 7). As such, since the lengths of the sustain periods of subfields are different from each other, it is possible to implement the gray-level of an image.

Meanwhile, image data of R (Red), G (Green), or B (Blue) input to the plasma display apparatus is processed while passing through various data processing blocks as shown in FIG. 3, so to be displayed on a PDP.

FIG. 3 is a block diagram of the conventional plasma display apparatus.

Referring to FIG. 3, the plasma display apparatus includes an inverse gamma corrector 310, a gain controller 320, a half-tone unit 330, a subfield mapping unit 340, a data arrangement unit 350, and a data driver 360, in order to process input data and address image data corresponding to each subfield to each line of a PDP. Also, the plasma display apparatus further includes a APL (Average Picture Level) unit 370 and a timing controller 380 for processing the image data and controlling driving pulses that will be applied to the scan electrodes, sustain electrodes, and address electrodes (not shown) of the PDP.

The inverse gamma corrector 310 gamma-corrects input image data using pre-stored gamma data and performs a linear-transform on a brightness value corresponding to the gray-level of the image data.

The gain controller 320 amplifies R, G, B image data corrected by the inverse gamma corrector 310 by a valid gain.

The half-tone unit 330 adds noise to the amplified R, G, B image data received from the gain controller 320 to finely adjust the gray-level, thus improving gray-level display capability.

The subfield mapping unit 340 maps the data received from the half-tone unit 330 to a predetermined subfield pattern, thus generating subfield mapping data spatially arranged.

The data arrangement unit 350 arranges the spatially arranged subfield mapping data received from the subfield mapping unit 340 into temporally arranged data.

The data driver 360 receives the temporally arranged data from the data arrangement unit 350 and supplies an address driving pulse to the address electrodes (not shown) of the PDP, thereby forming an image on the PDP.

Also, the APL unit 370 calculates an average value of the brightness signal of the input image data as average screen brightness.

The timing controller 380 decides the number of sustain pulses to be assigned to each subfield, according to the average screen brightness received from the APL unit 370, generates a logic pulse of controlling a driving waveform, and supplies the logic pulse to a high voltage driving circuit (not shown).

In the conventional plasma display apparatus, a Look-Up Table (LUT) is used to process image data in real time.

The LUT stores data one-to-one corresponding to all variables of image data. The LUT is referenced by devices, such as the inverse gamma corrector 310 and the half-tone unit 330, which need the data of the LUT. By outputting an object value corresponding to a variable using data of the LUT, the variable can be converted into appropriate data that can be processed by a corresponding device.

FIG. 4 illustrates a data transmission period in which data of a conventional LUT is transmitted.

Referring to FIG. 4, a vertical sync signal V_{SYNC} is a pulse for setting a line on which image data among input data exists. A period, in which no image data exists, corresponding to a head portion of a unit frame of the vertical sync signal V_{SYNC}, is a cessation period. The data of the LUT is transmitted during the cessation period, in order to process image data in real time.

However, if the LUT has a large amount of data, each device must assign longer time to transmit such a large amount of data. Therefore, to transmit a large amount of data of the LUT, an enhanced data compression method is needed.

### SUMMARY OF THE INVENTION

To solve this problem, an object of the present invention is to provide a plasma display apparatus capable of reducing the time used to transmit data of a Look-Up Table (LUT) by improving a method of compressing the data of the LUT, and an image processing method therefor.

To achieve the object, a plasma display apparatus according to a first embodiment of the present invention includes: a Look-Up Table (LUT) storage unit in which an object value corresponding to a variable of image data is stored; a data transmission unit transmitting decimal data corresponding to a decimal factor of the object value of the LUT; a data generator generating integer data corresponding to an integer factor of the object value in response to a change in the transmitted decimal data; and a data restoring unit restoring data corresponding to the object value using the generated integer data and the transmitted decimal data.

The data generator increases the integer data corresponding to the integer factor of the object value by a predetermined value, when the decimal data sharply decreases while gradually increasing.

The predetermined value is 1.

An image processing method, which is performed by the plasma display apparatus according to the first embodiment of the present invention, includes: storing an object value corresponding to a variable of image data in a Look-Up Table (LUT); transmitting decimal data corresponding to a decimal factor of the object value of the LUT; generating integer data corresponding to an integer factor of the object value in response to a change in the transmitted decimal data; and restoring data corresponding to the object value using the generated integer data and the transmitted decimal data.

According to the first embodiment of the present invention, since only the decimal factor of data to be transmitted from the LUT are transmitted, it is possible to reduce the amount of transmission data and thus reduce the time used to transmit the data. Here, respective devices included in the plasma display apparatus generate integer data increased by a predetermined value, when corresponding decimal data sharply decreases while gradually increasing. The respective devices included in the plasma display apparatus use data corresponding to a sum of the generated integer data and the transmitted decimal data.

To achieve the object, a plasma display apparatus according to a second embodiment of the present invention includes: a Look-Up Table (LUT) storage unit in which object value data corresponding to variables of image data are stored; data transmission unit transmitting at least two of the object value data of the LUT; a data generator generating data corresponding to an intermediate value of the transmitted data using the transmitted at least two data; and a data restoring unit restoring the object value data using the generated data and the transmitted data.

The data generator generates data corresponding to an intermediate value of the transmitted data using the transmitted data by interpolation.

An image processing method, which is performed by the plasma display apparatus according to the second embodiment of the present invention, includes: storing object value data corresponding to variables of image data in a Look-Up Table (LUT); transmitting at least two of the object value data of the LUT; generating data corresponding to an intermediate value of the transmitted at least two data using the transmitted at least two data; and restoring the object value data using the generated data and the transmitted at least two data.

According to the second embodiment of the present invention, at least two data are transmitted from the LUT and an intermediate value between the two data is generated using the transmitted data. Therefore, it is possible to minimize the amount of data to be transmitted from the LUT and thus reduce the time used to transmit the data. Here, the intermediate value between the two data is generated by interpolation. Each of devices included in the plasma display apparatus uses the transmitted data and the generated intermediate value data.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional plasma display panel (PDP);

FIG. 2 is a view for explaining an image processing method performed by a conventional plasma display apparatus;

FIG. 3 is a block diagram of the conventional plasma display apparatus;

FIG. 4 illustrates a data transmission period in which data of a conventional Look-Up Table (LUT) is transmitted;

FIG. 5 is a block diagram of a plasma display apparatus according to a first embodiment of the present invention;

FIG. 6A through 6C are graphs plotting data of a LUT according to the first embodiment of the present invention;

FIG. 7 is a view for explaining the characteristic of the LUT used in the plasma display apparatus according to the first embodiment of the present invention;

FIG. 8 is a view for explaining an image processing method performed by the plasma display apparatus according to the first embodiment of the present invention;

FIG. 9 is a block diagram of a plasma display apparatus according to a second embodiment of the present invention; and

FIG. 10 is a view for explaining an image processing method performed by the plasma display apparatus according to the second embodiment of the present invention.

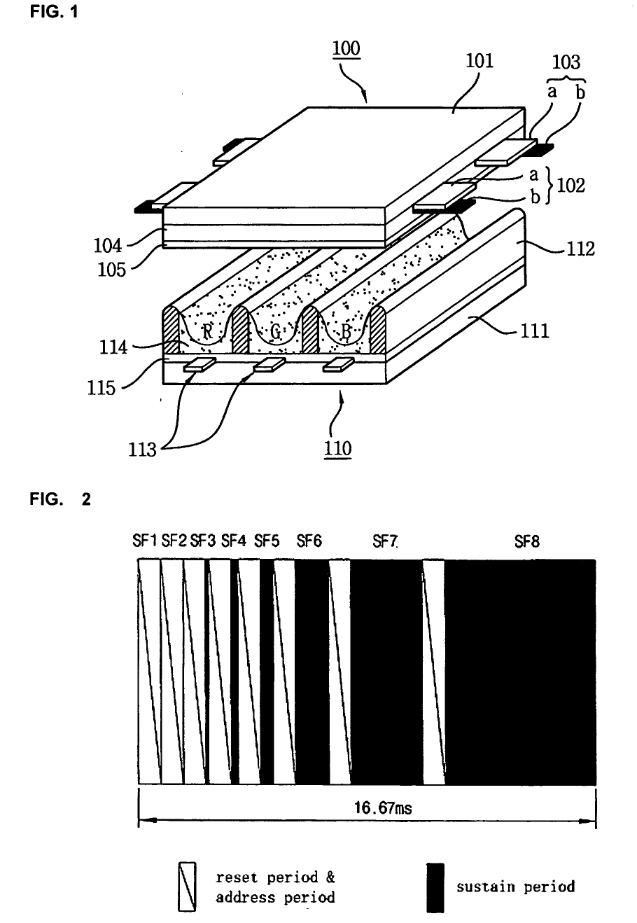

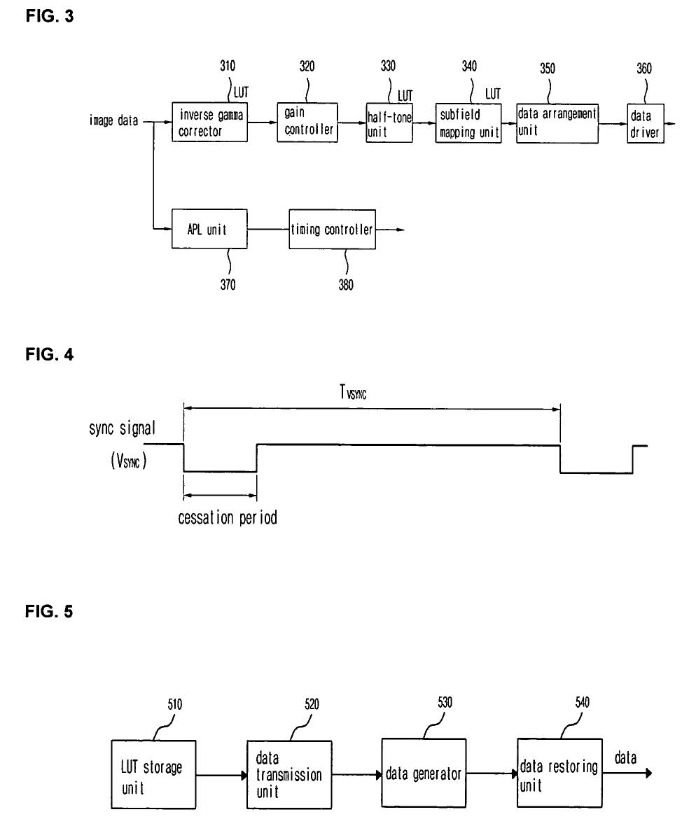

### DETAILED DESCRIPTION OF THE INVENTION

Hereinafter, embodiments of the present invention will be described with reference to the appended drawings.

### First Embodiment

FIG. 5 is a block diagram of a plasma display apparatus according to a first embodiment of the present invention.

Referring to FIG. 5, the plasma display apparatus according to the first embodiment of the present invention includes a Look-Up Table (LUT) storage unit 510, a data transmission unit 520, a data generator 530, and a data restoring unit 540.

The LUT storage unit 510 stores object values corresponding to variables of image data.

The data transmission unit 520 transmits data corresponding to the decimal factor of an object value of the LUT stored in the LUT storage unit 510.

The data generator 530 generates data corresponding to the integer factor of the object value, in response to a change in the transmitted decimal factor. The data generator 530 increases the integer data by a predetermined value, when the decimal data sharply decreases while gradually increasing. Here, the predetermined value may be 1. This will be described in detail later.

The data restoring unit 540 restores data of the object value using the generated integer data and the transmitted decimal data.

As such, since the data transmission unit 520 transmits only decimal data stored in the LUT 510, it is possible to reduce the amount of data to be transmitted. By reducing the amount of data to be transmitted, the time used to transmit the data can be reduced.

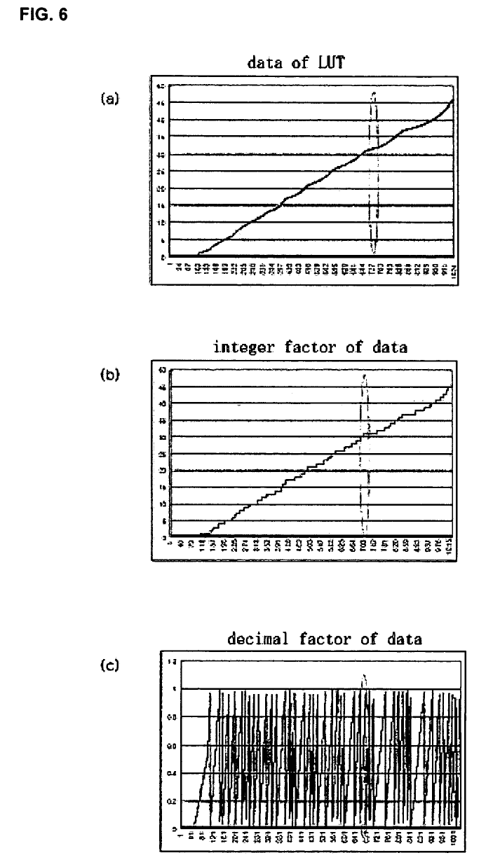

FIG. 6A through 6C are graphs plotting data of the LUT.

FIG. 6A is a graph plotting the data of the LUT.

In FIG. 6A, the data of the LUT is data regarding inverse gamma corrected gray-level values corresponding to input gray-level values, which are used by an inverse gamma corrector of a plasma display apparatus. Input gray-level values of 0 through 1024 are variables of input image data, and output gray-level values of 0 through 50 are object values corresponding to the variables of the input image data. As shown in the drawings, the input gray-level values one-to-one correspond to the output gray-level values. Now, the integer factors and the decimal factors of output gray-level values will be described respectively.

FIG. 6B is a graph plotting the integer factors of the output gray-level values and FIG. 6C is a graph plotting the decimal factors of the output gray-level values.

Referring to FIGS. 6B and 6C, integer factors increase in step form from 0 to 50, and the decimal factors have a sawtooth waveform swinging in a range larger than 0 but smaller than 1. Accordingly, as shown in FIG. 6A, the output gray-level values appear linearly by the sum of the integer factors and the decimal factors.

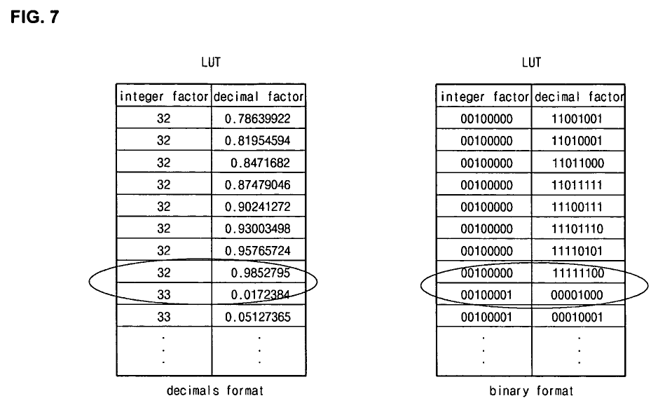

FIG. 7 is a view for explaining the characteristic of the LUT used by the plasma display apparatus according to the first embodiment of the present invention.

As shown in FIG. 7, since the integer factors appear in step form, there are portions where integer factors are the same while corresponding decimal factors increase. The decimal factors contain mainly important information. This is because a difference between an input gray-level value and a corresponding output gray-level value is a small value represented by a decimal number.

According to the first embodiment of the present invention, decimal factors containing important information among data corresponding to object values (that is, output gray-level values) of the LUT, are transmitted.

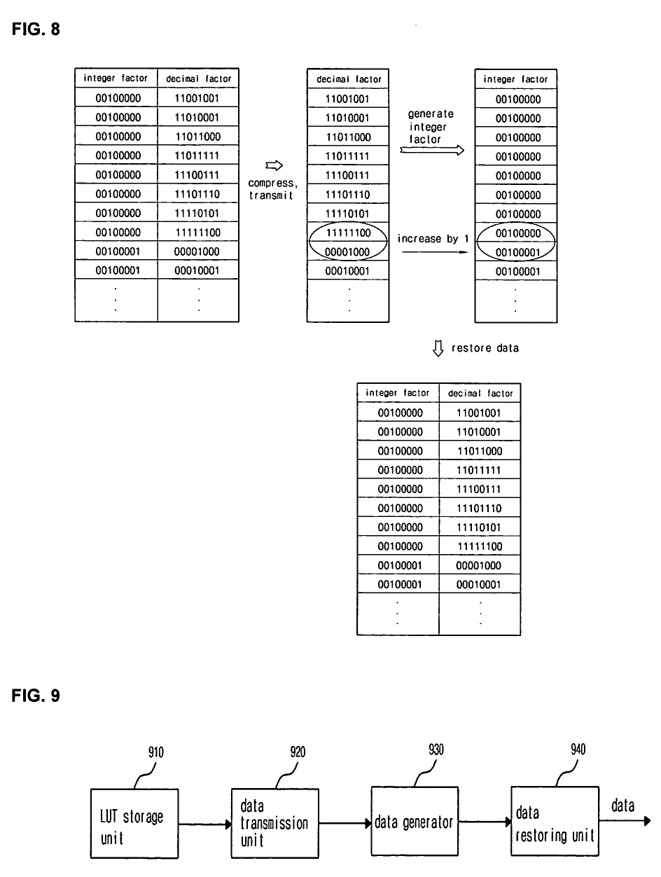

The integer factors of the data are generated in response to a change in the decimal factors. Now, a method for compressing data of the LUT will be described in detail with reference to FIG. 8.

FIG. 8 is a view for explaining an image processing method performed by the plasma display apparatus according to the first embodiment of the present invention.

Referring to FIG. 8, according to the first embodiment of the present invention, only the decimal factors of the data of the LUT are compressed. Then, the compressed decimal data are transmitted in a cessation period to each of devices requesting object values of the LUT.

The time used to transmit data of the LUT can be calculated by Equation 1.

(Time used to transmit data of a LUT)=(one transmission cycle)×(the amount of data to be transmitted from the LUT)÷(the amount of data to be transmitted during one transmission cycle) (1).

Now, a data transmission time according to the present invention will be described compared with a data transmission time according to a conventional technique, as follows.

According to a conventional technique, when one transmission cycle is 100 ns, the amount of data to be transmitted from a LUT is a value obtained by multiplying the number (1024) of data of output gray-level values by 16 bits of each data, and the amount of data to be transmitted during one transmission cycle is 1 word (16 bits), a data transmission time is 100 (ns)×1024×16 (bits)+1 (word)=102.4 μs.

According to the present invention, since the amount of data to be transmitted from a LUT is a value obtained by multiplying the number (1024) of data of output gray-level values by 8 bits of the decimal factors of each data, under the same condition that one transmission cycle is 100 ns and the amount of data to be transmitted during one transmission cycle is 1 word (16 bits), a data transmission time is 100 (ns)×1024×8 (bits) 1(word)=51.2 μs.

Accordingly, according to the present invention, it is possible to reduce the amount of data to be transmitted from a LUT to ½ and thus reduce a data transmission time to ½, compared with the conventional technique.

Also, the integer factor of data is generated in response to a change in the decimal factor of the data.

As shown in FIG. 7, the decimal factor of data tends to sharply decrease while gradually increasing. When the decimal factor of data sharply decreases, an integer factor increased by a predetermined value is generated. Here, the predetermined value may be 1.

Then, a sum of the transmitted decimal factor and the generated integer factor is obtained and the sum is used as data of a restored LUT.

### Second Embodiment

FIG. 9 is a block diagram of a plasma display apparatus according to a second embodiment of the present invention.

Referring to FIG. 9, the plasma display apparatus according to the second embodiment of the present invention includes a LUT storage unit 910, a data transmission unit 920, a data generator 930, and a data restoring unit 940.

The LUT storage unit 910 stores object values corresponding to variables of image data.

The data transmission unit 920 transmits at least two of the object values of the LUT stored in the LUT storage unit 510.

The data generator 930 generates data corresponding to an intermediate value between the at least two data, using the at least two data received from the data transmission unit 920. The data generator 930 generates the intermediate value by interpolation. This will be described in detail later.

The data restoring unit 940 restores the object value data using the generated data and the transmitted data.

Since the data transmission unit 920 transmits only a portion of data stored in the LUT storage unit 910, it is possible to reduce the time used to transmit the data.

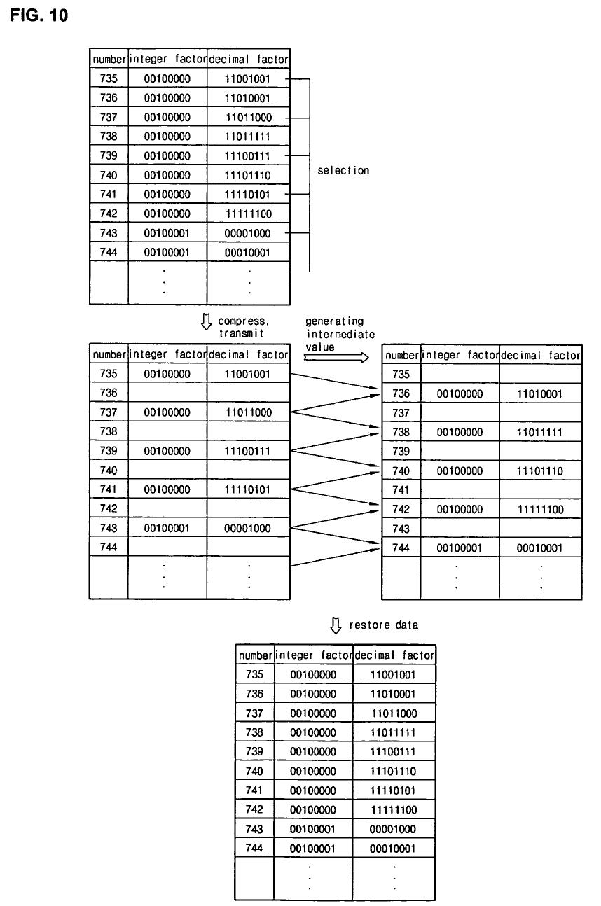

FIG. 10 is a view for explaining an image processing method performed by the plasma display apparatus according to the second embodiment of the present invention.

As shown in FIG. 10, according to the second embodiment of the present invention, at least two of data of a LUT are compressed and transmitted. For example, the n-th and (n+m+1)-th data (where n and m are integers) among n-th data, (n+1)-th data, . . . , (n+m)-th data, (n+m+1)-th data, . . . , corresponding to object values of the LUT, are transmitted to the respective devices of an image processing apparatus.

Here, the amount of data to be transmitted from the LUT can be arbitrarily set to ½ or less of the total amount of data of the LUT. As described above, due to the reduction in the amount of data to be transmitted from the LUT, the time used to transmit the data can be reduced according to Equation 1.

Meanwhile, it is possible to obtain (n+1)-th and (n+m)-th data corresponding to intermediate values of the transmitted n-th and (n+m+1)-th data using the n-th and (n+m+1)-th data. The (n+1)-th and (n+m)-th data can be obtained through interpolation.

Here, the interpolation is to predict a function value (values) for an arbitrary value (values) x existing between two or more values xⱼ(i=1, 2, . . . , n) with certain differences (the same differences or different differences), when a function f(x) for a real variable x is unknown but the function values f(xᵢ) for the two or more values xᵢ are known.

A simplest method is to obtain intermediate values using a curved line which connects coordinate points obtained by plotting variables on an x-axis and plotting known function values for the variables on a y-axis.

According to the second embodiment, the (n+1) and (n+m) data can be calculated according to Equation 2.

$$f ( X ) = f ( {X}_{0} ) + \frac{f ( {X}_{1} ) - f ( {X}_{0} )}{{X}_{1} - {X}_{0}} ( X - {X}_{0} ) \qquad ( 2 )$$

Equation 2 is an equation for relatively simple interpolation, called linear interpolation.

Alternately, the (n+1) and (n+m) data can be obtained by a method of approximating a function f(x) near variables x₀ and x₁ using function expansion. For a more accurate calculation, the Newton's interpolation formula can be used.

Then, the transmitted n-th and (n+m+1)-th data and the generated (n+1)-th and (n+m)-th data are arranged in order and the arranged data are used as data of a restored LUT.

As described above, in a plasma display apparatus according to the present invention, by improving a method for compressing data of a LUT, it is possible to reduce the time used to transmit the data of the LUT.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display apparatus comprising:
a Look-Up Table (LUT) storage unit storing an object value corresponding to a variable of image data;
a data transmission unit transmitting decimal data corresponding to a decimal factor of the object value of the LUT;
a data generator generating integer data corresponding to an integer factor of the object value in response to a change in the transmitted decimal data; and
a data restoring unit restoring the object value using the generated integer data and the transmitted decimal data.

2. The plasma display apparatus of claim 1, wherein the data generator increases the integer data corresponding to the integer factor of the object value by a predetermined value, when the decimal data decreases sharply after gradual increasing.

3. The plasma display apparatus of claim 2, wherein the predetermined value is 1.

4. A plasma display apparatus comprising:
a Look-Up Table (LUT) storage unit storing an object value data corresponding to variables of image data;
a data transmission unit transmitting at least two of the object value data of the LUT;
a data generator generating data corresponding to an intermediate value of the transmitted data using the transmitted data; and
a data restoring unit restoring the object value data using the generated data and the transmitted data.

5. The plasma display apparatus of claim 4, wherein the data generator generates data corresponding to an intermediate value of the object value data using the transmitted data by interpolation.

6. An image processing method for a plasma display apparatus, comprising the step of:
storing an object value corresponding to a variable of image data in a Look-Up Table (LUT);
transmitting decimal data corresponding to a decimal factor of the object value of the LUT;
generating integer data corresponding to an integer factor of the object value in response to a change in the transmitted decimal data; and
restoring data corresponding to the object value using the generated integer data and the transmitted decimal data.

7. The image processing method of claim 6, wherein the integer data is generated by increasing the integer factor of the object value by a predetermined value, when the decimal data decreases sharply after gradual increasing.

8. The image processing method of claim 6, wherein the predetermined value is

9. An image processing method for a plasma display apparatus, comprising the step of:
storing object value data corresponding to variables of image data in a Look-Up Table (LUT);
transmitting at least two of the object value data of the LUT;
generating data corresponding to an intermediate value of the transmitted data using the transmitted data; and
restoring the object value data using the generated data and the transmitted data.

10. The image processing method of claim 9, wherein the data corresponding to the intermediate value of the transmitted data is generated using the transmitted data by interpolation.
